(19) United States
(12) Patent Application Publication
(10) Pub. No.: US 2026/0274085 A1
(43) Pub. Date: Sep. 17, 2026

(54) INCHING CONTROL SYSTEM

(71) Applicant: Crown Equipment Corporation, New Bremen, OH (US)

(72) Inventors: Joseph Wilker, St. Marys, OH (US); Logan Pfeifer, St. Marys, OH (US); Daniel Huelsman, Versailles, OH (US); Ryan Smith, Celina (OH); Zachary Grilliot, Versailles, OH (US); Michael Largent, New Bremen, OH (US); Jacob Niekamp, New Weston, OH (US); Lee Magoto, Russia, OH (US)

(21) Appl. No.: 19/529,343

(22) Filed: Feb. 4, 2026

Related U.S. Application Data
(60) Provisional application No. 63/762,338, filed on Feb. 24, 2025.
(60) Provisional application No. 63/947,306, filed on Dec. 23, 2025.

(51) Int. Cl. B60L 15/20; B60L 7/18

(52) U.S. Cl. CPC B60L 15/2063; B60L 7/18; B60L 2200/42; B60L 2240/12; B60L 2240/16; B60L 2250/26

(57) ABSTRACT

A method is provided comprising: receiving, by one or more electronic processors on a materials handling vehicle: an input from a traction control device and an input from an inching device. The one or more electronic processors are collectively configured to: determine a speed setpoint input value based on the traction control device input; determine a speed modification value based on the inching device input; determine a target speed setpoint based on the speed modification value and the speed setpoint input value; and control a traction motor on the vehicle based on the target speed setpoint.

### CROSS REFERENCE TO RELATED APPLICATIONS

This application claims the benefit of U.S. Provisional Patent Application Ser. No. 63/762,338, filed Feb. 24, 2025, entitled “INCHING CONTROL SYSTEM”, and U.S. Provisional Patent Application Ser. No. 63/947,306, filed Dec. 23, 2025, entitled “INCHING CONTROL SYSTEM”, the disclosures of which are hereby incorporated by reference.

### BACKGROUND

U.S. Pat. No. 8,775,039 discloses a dual-purpose inch/brake pedal in an engine-based vehicle. The inch/brake pedal operates to engage a vehicle braking system, and also to engage a vehicle transmission. Typically, the braking system is fully engaged when the inch/brake pedal is fully depressed, whereas the vehicle transmission is fully engaged when the inch/brake pedal is fully released. Inching occurs in an intermediate range of motion of the inch/brake pedal when the vehicle transmission is only partially engaged.

### BRIEF SUMMARY

In accordance with a first aspect, a method is provided comprising: receiving, by one or more electronic processors on a materials handling vehicle: an input from a traction control device; an input from an inching device; wherein the one or more electronic processors are collectively configured to: determine a speed setpoint input value based on the traction control device input; determine a speed modification value based on the inching device input; determine a target speed setpoint based on the speed modification value and the speed setpoint input value; and control a traction motor on the vehicle based on the target speed setpoint. The traction motor may comprise an electrically powered traction motor.

When the inching device input is greater than a predefined inching device value, the speed modification value may be equal to 0 such that the target speed setpoint is equal to zero units of speed.

The inching device input may have a range from 0% to 100%. The predefined inching device input value may fall within a range from 1% to 70%.

When the target speed setpoint is greater than a current vehicle speed, the one or more electronic processors may determine an acceleration rate for the vehicle to reach the target speed setpoint independent of the inching device input.

When the target speed setpoint is less than a current vehicle speed, the one or more electronic processors may determine a braking rate for the vehicle to reach the target speed setpoint based on the inching device input.

The inching device may comprise an inching pedal. When the inching pedal is being depressed, a first lookup table may be used by the one or more electronic processors to determine the braking rate and when the inching pedal is being released, a second lookup table different from the first lookup table may be used by the one or more electronic processors to determine the braking rate.

The traction motor may be capable of operating in a motoring mode when the target speed setpoint is greater than a current vehicle speed or a regenerative braking mode when the target speed setpoint is less than the current vehicle speed. The one or more processors may determine a power limit when the motor is operating in the motoring mode or the regenerative braking motor, wherein the power limit may vary based on the inching device input.

When the inching device input is greater than a predefined inching device value, the speed modification value may be equal to 0 such that the target speed setpoint is equal to zero units of speed. When the traction motor is operating in the motoring mode, the one or more processors may use a motor power limit lookup table to determine a motor power limit modification value using the inching device input. The one or more processors may determine a target motor power limit using the motor power limit modification value and a maximum motor power limit value.

When the inching device input is greater than the predefined inching device value and between a first value and a second value, the power limit modification value may be equal to zero resulting in the target power limit equal to 0 units of power, thereby causing the vehicle to coast.

When the inching device input is greater than a predefined inching device value, the speed modification value may be equal to 0 such that the speed target setpoint is equal to zero units of speed. When the traction motor is operating in the regenerative braking mode, the one or more processors may use a regenerative power limit lookup table to determine a regenerative power limit modification value using the inching device input. The one or more processors may determine a target regenerative power limit using the regenerative power limit modification value and a maximum regenerative power limit value.

A materials handling vehicle control system is provided comprising: one or more memory components storing executable instructions; one or more electronic processors in communication with the one or more memory components; a traction control device for generating a traction control device input; an inching device for generating an inching device input; and execution of the executable instructions by the one or more electronic processors may cause the one or more electronic processors to collectively: determine: (i) a speed setpoint input value based on the traction control device input, (ii) a speed modification value based on the inching device input and (iii) a target speed setpoint based on the speed modification value and the speed setpoint input value; and control a traction motor on the vehicle based on the target speed setpoint. “Execution of the executable instructions by the one or more electronic processors may cause the one or more electronic processors to collectively: determine: (i) a speed setpoint input value based on the traction control device input, (ii) a speed modification value based on the inching device input and (iii) a target speed setpoint based on the speed modification value and the speed setpoint input value; and control a traction motor on the vehicle based on the target speed setpoint” means that a single electronic processor may determine each of functions (i)-(iii) and control the traction motor or the functions (i)-(iii) and the control of the traction motor may be divided among two or more electronic processors. For example, a first electronic processor may determine function (i), a second electronic processor may perform function (ii) a third electronic processor may determine function (iii) and a fourth electronic processor may control the traction motor or a first processor may perform one, two or three of functions (i)-(iii) and control of the traction motor and a second electronic processor may perform the remaining functions (i)-(iii) and control of the traction motor not performed by the first processor. It is still further contemplated that a first processor may perform functions (i)-(iii) and a second electronic processor may control the traction motor.

When the inching device input is greater than a predefined inching device value, the one or more processors may determine that the speed modification value is equal to 0 and the speed target setpoint is equal to zero units of speed.

The inching device input may have a range from 0% to 100%. The predefined inching device input value may fall within a range from 1% to 70%.

When the target speed setpoint is greater than a current vehicle speed, the one or more electronic processors may determine an acceleration rate for the vehicle to reach the target speed setpoint independent of the inching device input.

When the target speed setpoint is less than a current vehicle speed, the one or more electronic processors may determine a braking rate for the vehicle to reach the target speed setpoint based on the inching device input.

The inching device may comprise an inching pedal. When the inching pedal is being depressed, a first lookup table may be used by the one more electronic processors to determine the braking rate and when the inching pedal is being released, a second lookup table different from the first lookup table may be used by the one or more processors to determine the braking rate.

The one or more processors may be capable of operating the traction motor in a motoring mode when the target speed setpoint is greater than a current vehicle speed or a regenerative braking mode when the target speed setpoint is less than the current vehicle speed. The one or more processors may determine a power limit when the motor is operating in the motoring mode or the regenerative braking motor, wherein the power limit may vary based on the inching device input.

When the inching device input is greater than a predefined inching device value, the speed modification value may be equal to 0 such that the speed target setpoint is equal to zero units of speed. When the traction motor is operating in the motoring mode, the one or more processors may use a motor power limit lookup table to determine a motor power limit modification value using the inching device input. The one or more processors may determine a target motor power limit using the motor power limit modification value and a maximum motor power limit value.

When the inching device input is greater than the predefined inching device value and between a first value and a second value, the power limit modification value may be equal to zero resulting in the target power limit equal to 0 units of power, thereby causing the vehicle to coast.

When the inching device input is greater than a predefined inching device value, the speed modification value may be equal to 0 such that the speed target setpoint is equal to zero units of speed. When the traction motor is operating in the regenerative braking mode, the one or more processors may use a regenerative power limit lookup table to determine a regenerative power limit modification value using the inching device input. The one or more processors may determine a target regenerative power limit using the regenerative power limit modification value and a maximum regenerative power limit value.

### BRIEF DESCRIPTION OF THE SEVERAL VIEWS OF THE DRAWINGS

FIG. 1 is a perspective view of a materials handling vehicle illustrated as a sit-down counterbalanced lift truck operable in accordance with teachings of the present application;

FIG. 2 is a side plan view of the counterbalanced lift truck of FIG. 1;

FIG. 2A illustrates a portion of a floorboard of the vehicle and an accelerator pedal, an inching control pedal and a braking pedal;

FIG. 3 is schematic view of several components of the materials handling vehicle of FIGS. 1 and 2;

FIGS. 4-9 are example plots from which a speed setpoint input value, a speed modification value, a braking rate and a power limit modification value may be determined; and

FIGS. 10-12 depict flowcharts of example control algorithms or methods of implementing aspects of the disclosure.

### DETAILED DESCRIPTION

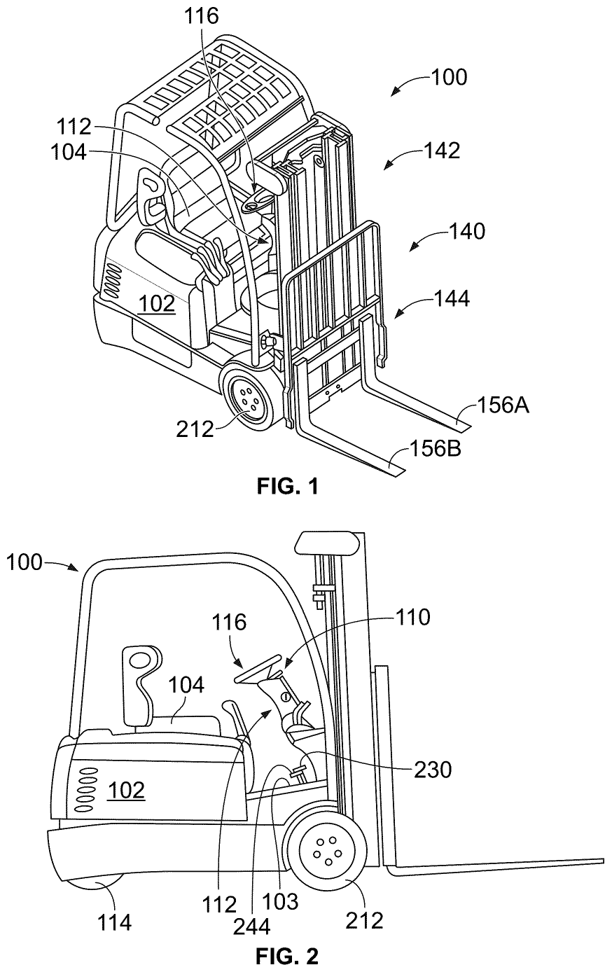

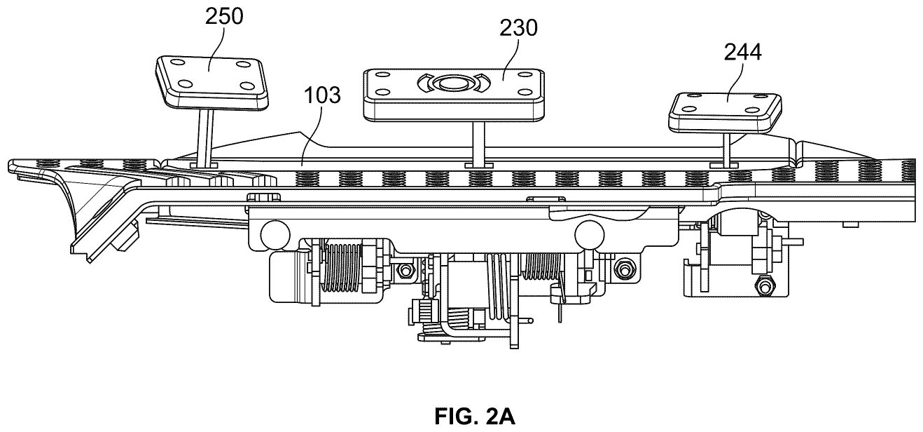

Reference is made to FIGS. 1 and 2, which are perspective and side plan views, respectively, of a materials handling vehicle comprising a three-wheel sit-down counterbalanced lift truck 100. While the method and system for controlling materials handling vehicles set out herein may be used in the sit-down counterbalanced lift truck 100, it will be apparent to those skilled in the art that the subject matter set out herein and variations thereof may be incorporated into a variety of other materials handling vehicles (also referred to herein as “industrial vehicles”), including any Class I, II or III materials handling vehicles.

The vehicle 100 includes a main body or power unit 102, which includes a frame defining a main structural component of the vehicle 100 and which houses a battery (not shown) for powering various components of the vehicle 100. The vehicle 100 further comprises first and second driven wheels 212 mounted to a front side of the power unit 102 and a steered wheel 114 mounted to a rear of and generally under the power unit 102, see FIG. 2.

An operator's compartment is located within the power unit 102 for receiving an operator driving the vehicle 100. An operator seat 104 may be provided in the operator's compartment. A steering wheel 116 may be provided on a steering column 112 within the operator's compartment for controlling steering of the vehicle 100. Steering may also be accomplished via a joystick control, which may be mounted on an armrest. The direction of movement (forward or reverse) of the vehicle 100 may be controlled by the operator via a forward reverse lever 110. The speed of the vehicle 100 may be controlled by the operator using a traction control input device, such as a foot actuated accelerator pedal 244, which may extend through a floorboard 103 of the power unit 102, see FIGS. 2 and 2A. It is also contemplated that the traction control input device may comprise a hand control input, which may, for example, be positioned on the steering column 112, on the steering wheel 116 or an armrest (not shown) within the operator's compartment. Vehicle braking may be controlled by the operator using a brake control device, such as a foot actuated braking pedal 230, which may extend through the floorboard 103, see FIGS. 2 and 2A. An inching control device may be provided. The inching control device may comprise an inching control pedal 250, which may extend through the floorboard 103, see FIG. 2A (the inching control pedal 250 is not illustrated in FIG. 2). For purposes of illustration, the inching control device will be described herein as an inching control pedal 250, however, it is contemplated that the inching control device may alternatively comprise a hand control input, which may, for example, be positioned on the steering column 112, on the steering wheel 116 or on an armrest. The inching control pedal 250 may function to attenuate an operator requested vehicle speed setpoint input value and/or a power limit, such as when the vehicle is operating in a motoring mode or a regenerative braking mode, as discussed further below. The inching control pedal 250 may also vary a braking rate during an “inching function,” as discussed further below. The braking pedal 230 may be positioned between the accelerator pedal 244 and the inching control pedal 250, see FIG. 2A. The vehicle 100 may further include an overhead guard including a vertical support structure affixed to the vehicle frame.

A load handling assembly 140 of the vehicle 100, coupled to the power unit 102, may include, generally, a mast assembly 142 and a carriage assembly 144, which is movable vertically along the mast assembly 142. The mast assembly 142 may include a fixed mast member affixed to the frame, and nested first and second movable mast members. It is noted that the mast assembly 142 may include additional or fewer movable mast members than the two shown in FIG. 1, i.e., the first and second movable mast members. The carriage assembly 144 may include conventional structure including a fork carriage and fork structure comprising a pair of forks 156A, 156B.

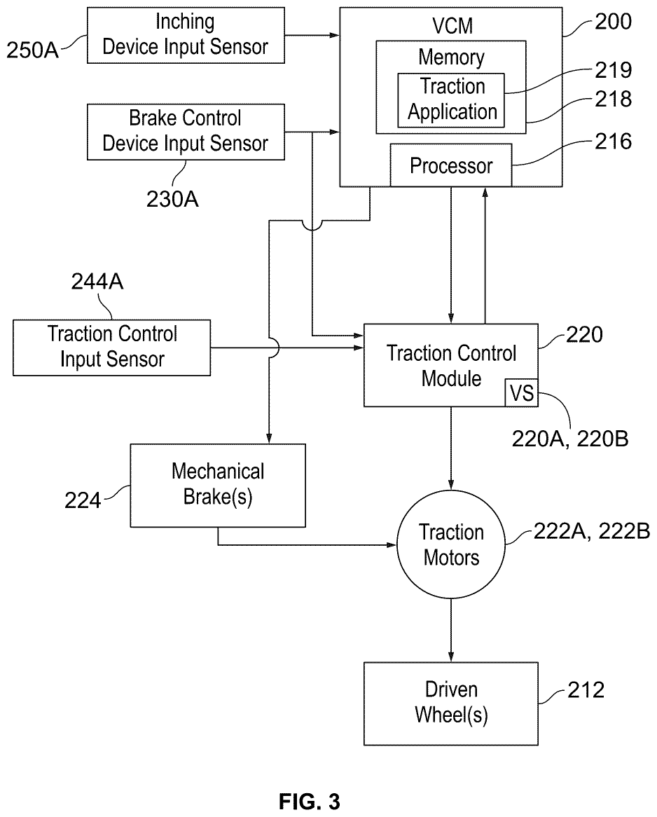

FIG. 3 depicts a block-level view of a computing environment for providing control logic and software applications in a vehicle control module (VCM) 200, according to one or more embodiments shown and described herein. In the illustrated embodiment, the VCM 200 may include one or more electronic processors or microcontrollers 216, input/output hardware, network interface hardware, one or more data storage components, and one or more memory components 218. The one or more data storage components and the one or more memory components 218 may each be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Any stored information that is intended to be available after the vehicle 100 is shut down and restarted may beneficially be stored in non-volatile memory. Also, depending on the particular embodiment, the non-transitory computer-readable medium, mentioned above, may reside within the VCM 200 and/or external to the VCM 200.

Additionally, the one or more memory components 218 may store software or applications that can be executed (i.e., using executable code) by the one or more electronic processors or microcontrollers 216. Thus, the one or more memory components 218 may store an operating application or logic, a traction application or logic 219, and a steering application or logic. The operating logic may include an operating system and other software such as, for example, diagnostic-related applications for managing components of the VCM 200. The traction application or logic 219 may be configured with one or more algorithms and parameters for facilitating optimal traction control for the vehicle 100. The steering application or logic may be configured with one or more algorithms and parameters for facilitating optimal steering control of the vehicle 100. A local communication interface may also be included and may be implemented as a bus or other communication interface to facilitate communication among the components of the VCM 200.

The one or more processors or microcontrollers 216 may include any processing component operable to receive and execute instructions (such as from the one or more data storage components and/or the one or more memory components 218). The one or more processors or microcontrollers 216 may comprise any kind of a device which receives input data, processes that data through computer instructions, and generates output data. Such a processor can be a microcontroller, a hand-held device, laptop or notebook computer, desktop computer, microcomputer, digital signal processor (DSP), mainframe, server, cell phone, personal digital assistant, other programmable computer devices, or any combination thereof. Such processors can also be implemented using programmable logic devices such as field programmable gate arrays (FPGAs) or, alternatively, realized as application specific integrated circuits (ASICs) or similar devices. The term “processor” is also intended to encompass a combination of two or more of the above recited devices, e.g., two or more microcontrollers.

It should be understood that the components illustrated in FIG. 3 are merely exemplary and are not intended to limit the scope of this disclosure. While the operating application or logic, the traction application or logic 219, and the steering application or logic are discussed herein as residing on the VCM 200, this is merely an example, as one or more of the operating application or logic, the traction application or logic 219, and the steering application or logic may reside on different devices. Additionally, while the VCM 200 is discussed herein with the traction application 219, the steering application, and the accessory application as separate logical components, this is also an example. In some embodiments, a single, composite software application may cause the VCM 200 to provide the described functionality.

The vehicle may comprise one of a number of cooperating modules, such as the VCM 200, a traction control module (TCM) 220, a steering control module (SCM) and/or a hydraulic control module (HCM), that cooperatively control operation of the vehicle 100. The VCM 200, TCM 220, the SCM and the HCM may communicate with one another via a controller area network (CAN) interface or any other serial communication variant. It is also contemplated that the VCM 200, TCM 220, HCM and/or the SCM may be provided as a single module operating on a single electronic device. In the embodiment of FIG. 3, the TCM is a separate device from the VCM 200. The TCM 220 may comprise one or more electronic processors or microcontrollers and one or more memory components, such as for storing executable instructions.

As noted above, the VCM 200 may include the microcontroller 216 that includes the traction application 219. As also noted above, the speed of the vehicle 100 may be controlled by the operator actuated accelerator pedal 244. Downward movement of the accelerator pedal 244 may cause actuation of a traction control device input sensor 244A, such as a potentiometer, a hall effect sensor or an encoder, which may be coupled to or otherwise associated with the accelerator pedal 244 and may generate a traction control device input signal that corresponds or can be processed to correspond to the position of the accelerator pedal 244. Traction control device input signals generated by the traction control device input sensor 244A may be provided to an input pin of the TCM 220, which then forwards the traction control device input signals to the microcontroller 216 of the VCM 200 with no substantive modification. It is also contemplated that the traction control device input sensor 244A may provide the traction control device input signals directly to the VCM 200.

As noted above, vehicle braking may be controlled by the operator using the foot actuated braking pedal 230. Downward movement of the braking pedal 230 may cause actuation of a brake control device input sensor 230A, such as a potentiometer, a hall effect sensor or an encoder, which may be coupled to or otherwise associated with the brake pedal 230 and may generate a brake control device input signal that corresponds or can be processed to correspond to the position of the brake pedal 230. Brake control device input signals generated by the brake control device input sensor 230A may be provided to an input pin of the microcontroller 216 of the VCM 200 and an input pin of the TCM 220.

The inching control pedal 250 may be controlled by an operator by moving the inching pedal 250 downward toward the floorboard 103 and may be released by the operator such that the pedal 250 returns, such as via a spring bias, towards or to its home position. Movement of the inching control pedal 250 toward or away from the floorboard 103 may cause actuation of an inching device input sensor 250A, such as a potentiometer, hall effect sensor or an encoder, which may be coupled to or otherwise associated with the inching pedal 250 and may generate an inching device input signal that corresponds or can be processed to correspond to the position of the inching pedal 250. Inching device input signals generated by the inching device input sensor 250A may be provided to an input pin of the microcontroller 216 of the VCM 200.

The VCM 200 (the traction application) monitors the traction control device input signals (also referred to herein as “a traction control input”) received from the TCM 220, the brake control device input signals (also referred to herein as “a brake control device input”) received from the brake control device input sensor 230A and the inching device input signals (also referred to herein as “an inching device input”) received from the inching device input sensor 250A. Traction control input signals may be converted by the VCM 200 and the TCM 220 to a value from 0% or 0 units, which correspond to a 0 or a minimum accelerator pedal position, to 100% or 100 units, which corresponds to a maximum accelerator pedal position. Brake control device input signals may be converted by the VCM 200 and TCM 220 to a value from 0% or 0 units, which corresponds to 0 or minimum brake pedal position to 100% or 100 units, which corresponds to a maximum brake pedal position. Inching device input signals may be converted by the VCM 200 to a value from 0% or 0 units, which corresponds to 0 or minimum inching pedal position to 100% or 100 units, which corresponds to a maximum inching pedal position.

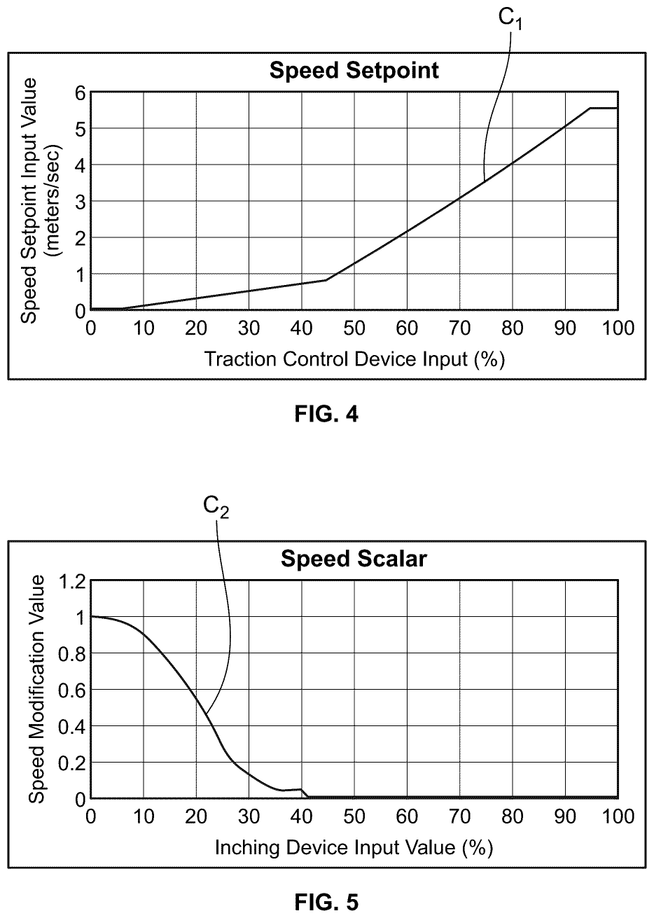

The traction application 219 on the VCM 200 receives the traction control device input signals from the TCM 220, which, as noted above, are received by the TCM 220 from the traction control device input sensor 244A and provided by the TCM 220 to the VCM 200 with no substantive modification. Based on the traction control device input signal, the VCM 200 determines a vehicle speed setpoint input value. The “vehicle speed setpoint input value” is a value corresponding to a desired speed for the vehicle, as indicated by the traction control device input signal generated by the traction control device input sensor 244A, which corresponds to the position of the accelerator pedal 244. FIG. 4 provides an example curve C₁ illustrating how the VCM 200 may calculate a vehicle speed setpoint input value based on the traction control device input signal. Along the x-axis are traction control device input values ranging from 0% or 0 units, which corresponds to 0 or a minimum accelerator pedal position to 100% or 100 units, which corresponds to maximum accelerator pedal position. Along the y-axis are vehicle speed setpoint input values ranging from 0 units of speed to 6 units of speed. The speed setpoint input values may have any value. In the illustrated embodiment, the units of speed are m/s. As can be seen from Curve C₁, if the traction control device input value is equal to about 30%, the vehicle speed setpoint input value is equal to about 0.5 m/s. If the traction control device input value is equal to about 60%, the speed setpoint input value is equal to about 2.0 m/s. The shape of curve C₁ is provided only as an example and the shape of curve C₁ may vary in any desired manner.

The VCM 200 may contain one or more equations in the one or more memory components 218 defined in accordance with Curve C₁ in FIG. 4 or a similar curve to allow the VCM 200 to use an input such as a traction control device input value to calculate a speed setpoint input value. Alternatively, the VCM 200 may include a lookup table stored in the one or more memory components 218 which stores points/data from a curve similar to or the same as curve C₁ from FIG. 4 such that a traction control device input value may be used by the VCM 200 as an input into the lookup table and receive as an output from the lookup table a vehicle speed setpoint input value.

The traction application 219 on the VCM 200 also monitors and receives the inching device input signals from the inching device input sensor 250A. Based on the inching device input signal, the VCM 200 may determine a speed modification value, which may be used by the VCM 200 with the vehicle speed setpoint input value to determine a vehicle target speed setpoint. FIG. 5 provides an example curve C₂ illustrating how the VCM 200 may calculate a speed modification value based on the inching device input signal. Along the x-axis are inching device input values ranging from 0% or 0 units, which corresponds to 0 or a minimum inching pedal position to 100% or 100 units, which corresponds to maximum depressed inching pedal position. Along the y-axis are speed modification values. In the illustrated embodiment, the speed modification values may comprise speed scalar or multiplication factors ranging from 0.0 to 1.2. The speed scalar or multiplication factors in FIG. 5 are provided for illustration purposes and may comprise any desired speed scalar or multiplication factors. The VCM 200 may determine a speed scalar or speed multiplication factor based on the inching device input value and multiply the speed scalar or speed multiplication factor by the vehicle speed setpoint input value, determined from FIG. 4, to determine the vehicle target speed setpoint. As a result, the speed scalar or speed multiplication factor functions to attenuate the operator requested vehicle speed setpoint input value. Hence, the operator uses the inching pedal 250 to reduce the speed of the vehicle. For example, if the inching device input value is equal to 10%, the speed modification value is equal to about 0.9. If the vehicle speed setpoint input value is equal to about 2.0 m/s and the speed modification value is equal to 0.9, then the vehicle target speed setpoint is equal to 1.8 m/s. In the FIG. 5 example, if the inching device input value is equal to a value falling within a range from about 41% to 100%, the speed modification value is equal to about 0. Hence, the vehicle target speed setpoint will equal 0 m/s. Where the speed modification value first equals 0, the corresponding inching device input value is referred to herein as a “predefined inching device value,” which is equal to 41% in the FIG. 5 example. While the predefined inching device value is equal to 41% in the illustrated embodiment, it may have any value. For example, the predefined inching device value may comprise a value falling within a range from about 1% to about 70%. The VCM 200 forwards the vehicle target speed setpoint to the TCM 220. The TCM 220 controls the operation of first and second electric traction motors 222A and 222B coupled to driven wheels 212 in an attempt to cause the vehicle to reach the vehicle target speed setpoint using defined limits of acceleration or braking rates and a maximum power limit, as discussed further below. While the vehicle target speed setpoint is discussed herein as a target linear speed setpoint for the vehicle, the vehicle target speed setpoint may be converted by the VCM 200 or TCM 220 via a simple mathematical calculation, i.e., by multiplying the vehicle target speed setpoint by a constant value, to a rotational speed setpoint for each of the traction motors 222A, 222B, such that the TCM 220 may control the actual rotational speed of the traction motors 222A, 222B to the rotational speed setpoint for the traction motors 222A, 222B.

The VCM 200 may contain one or more equations in the one or more memory components 218 defined in accordance with Curve C₂ in FIG. 5 or a similar curve to allow the VCM 200 to use an input such as an inching device input value to determine a speed modification value. Alternatively, the VCM 200 may include a lookup table stored in the one or more memory components 218 which stores points/data from a curve similar to or the same as curve C₂ from FIG. 5 such that an inching device input value may be used by the VCM 200 as an input into the lookup table and receive as an output from the lookup table a speed modification value.

The TCM 220 may receive a first velocity signal from a first velocity encoder 220A coupled to the first traction motor 222A, which first velocity signal corresponds to the rotational velocity of the first traction motor 222A, and a second velocity signal from a second encoder 220B coupled to the second traction motor 222B, which second velocity signal corresponds to the rotational velocity of the second traction motor 222B. The velocity signals may be provided from the TCM 220 to the VCM 200. The TCM 220 and VCM 200 can determine a measured linear vehicle speed from the rotational velocity signals generated by one or both of the encoders 220A and 220B via a simple mathematical calculation, e.g., by multiplying a velocity signal from one of the encoders 220A and 220B by a constant.

When the vehicle target speed setpoint is greater than a current linear vehicle speed, which current linear vehicle speed is calculated from rotational velocity signals sampled from one or both of the velocity encoders 220A, 220B, the VCM 200 will command the TCM 220 to increase the speed of the traction motors 222A and 222B in an attempt to cause the vehicle to reach the vehicle target speed setpoint at a predefined vehicle acceleration value, such as 0.5 m/s². Hence, the predefined acceleration value determines how quickly the vehicle will accelerate to the new vehicle target speed setpoint. The predefined acceleration value may not vary based on the position of the inching pedal, i.e., the value of the predefined acceleration value may be fixed and independent of the inching device input value. However, the actualized acceleration of the vehicle may be reduced or even equal 0 m/s² if a low or zero target motor power limit, discussed below, will not allow the TCM 220 to control the traction motors 222A and 222B to accelerate the vehicle at the predefined vehicle acceleration value.

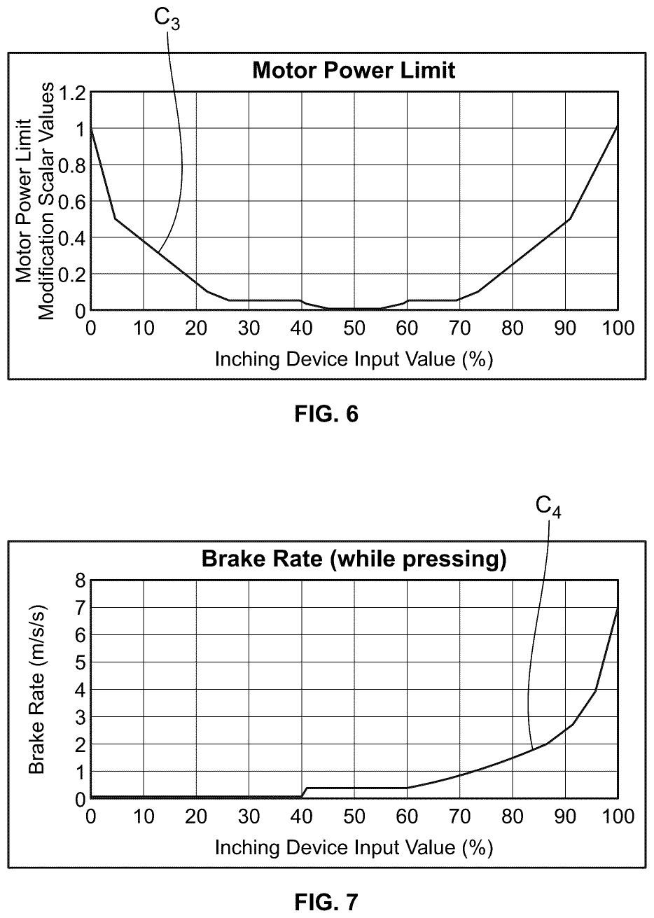

The VCM 200 may provide the TCM 220 with a target motor power limit when the vehicle is operating in a motoring mode. A “motoring mode” occurs when the vehicle target speed setpoint value is greater than a current measured vehicle speed, which current measured vehicle speed may be calculated from one or both encoders 220A, 220B associated with the traction motors 222A, 222B, as noted above. The VCM 200 may determine the target motor power limit based on the inching device input signal. FIG. 6 provides an example curve C₃ providing motor power limit modification values, which the VCM 200 may use to calculate a target motor power limit based on the inching device input signal. Along the x-axis are inching device input values ranging from 0% or 0 units, which corresponds to 0 or a minimum inching pedal position to 100% or 100 units, which corresponds to maximum depressed inching pedal position. Along the y-axis are motor power limit modification values. In the illustrated embodiment, the motor power limit modification values may comprise scalar or multiplication factors ranging from 0.0 to 1.2. To determine the target motor power limit, a motor power limit modification value from FIG. 6 is multiplied by a default maximum traction motor power limit, which may comprise, for example, 60 kilowatts. The default maximum traction motor power limit may comprise any desired value. If, for example, the inching device input value is equal to 10%, the motor power limit modification value is equal to about 0.39, see FIG. 6. Hence, the motor power limit modification value, 0.39, is multiplied by the default value of 60 kilowatts, to calculate a target motor power limit of 23.4 kilowatts. The VCM 200 communicates the determined target motor power limit to the TCM 220 such that the TCM 220 will limit the power consumed or used by each traction motor 222A and 222B to the target limit while the TCM attempts to accelerate the traction motors 222A and 222B to cause the vehicle to reach the target speed setpoint. The target motor power limit takes priority over the predefined acceleration value. The TCM 220 will allow each of the traction motors 222A and 222B to accelerate the vehicle at the predefined acceleration value to reach the vehicle target speed setpoint so long as the total power consumed by each traction motor 222A, 222B does not exceed the target motor power limit. In the illustrated embodiment, the “target motor power limit” is a power limit for each of the traction motors 222A, 222B, but could be a limit for a summation of power consumed by both traction motors 222A, 222B. If the total power consumed by each traction motor 222A, 222B to effect acceleration of the vehicle at the predefined vehicle acceleration value would exceed the target motor power limit, the TCM 220 will reduce the acceleration rate or velocity of each motor 222A, 222B so that the power consumed by each motor does not exceed the target motor power limit. Hence, the actualized acceleration of the vehicle may be less than the predefined vehicle acceleration value. Further, the vehicle speed may not reach the target speed setpoint if the power needed by each motor to reach the target speed setpoint exceeds the target motor power limit, for example, when the target motor power limit is equal to 0 kilowatts.

The VCM 200 may contain one or more equations in the one or more memory components 218 defined in accordance with Curve C₃ in FIG. 6 or a similar curve to allow the VCM 200 to use an input such as an inching device input value to determine a motor power limit modification value. Alternatively, the VCM 200 may include a lookup table stored in the one or more memory components 218 which stores points/data from a curve similar to or the same as curve C₃ from FIG. 6 such that an inching device input value may be used by the VCM 200 as an input into the lookup table and receive as an output from the lookup table a motor power limit modification value for use when the vehicle is operating in the motoring mode.

When the vehicle target speed setpoint is less than a current vehicle speed, as measured by one or both of the velocity encoders 220A and 220B, the VCM 200 will command the TCM 220 to reduce the speed of the traction motors 222A and 222B in an attempt to cause the vehicle to reach the vehicle target speed setpoint using a vehicle braking rate or deceleration value, which vehicle braking rate/deceleration value may vary based on whether the inching control pedal 250 is being activated. If the inching control pedal 250 is being activated, the braking rate/deceleration may vary based on whether the inching pedal is being depressed inwardly or released outwardly and also based on the inching device input signal, i.e., the inching pedal position. If the inching control pedal 250 and braking pedal 230 are not being activated, the braking rate/deceleration rate may be a constant value when the TCM 220 reduces the speed of the vehicle to the lower target speed setpoint. The VCM 200 can determined whether the inching control pedal 250 is being depressed or released based on consideration of sequential inching device input values from the inching device input sensor 250A, which are sampled over time by the VCM 200. For example, if the sequential inching device input values are increasing in value over time, then the VCM 200 determines that the inching control pedal 250 is being depressed, i.e., pressed inwardly. If the sequential inching device input values are decreasing in value over time, then the VCM 200 determines that the inching control pedal 250 is being released.

FIG. 7 provides an example curve C₄ illustrating how the VCM 200 may calculate a vehicle brake or braking rate based on the inching device input signal when the inching control pedal 250 is being pressed inwardly, i.e., being depressed. Along the x-axis are inching device input values ranging from 0% or 0 units, which corresponds to 0 or a minimum inching pedal position to 100% or 100 units, which corresponds to maximum depressed inching pedal position. Along the y-axis are vehicle braking rates in units of m/s². To determine a vehicle braking rate when the inching pedal 250 is being pushed inwardly, the VCM 200 uses curve C₄ in FIG. 7 and a current inching device input value. For example, if the inching device input value is equal to 50% while the inching pedal 250 is being depressed, the braking rate is equal to about 0.39 m/s². For inching device values from 0 % to 40%, the curve C₄ in FIG. 7 indicates that the braking rate is equal to 0 m/s². However, for inching device values of 0% to 40%, an option may be provided to allow a technician/customer to vary the braking rate for those values. Hence, the braking rate may alternatively be defined by a technician/customer to be 0.5 m/s² or any other rate instead of 0 m/s² for inching device values from 0% to 40%. For example, the braking rate at an inching device value of 41% would be 0.39 m/s², a decrease from 0.5 m/s² at an inching device value of 40%.

The VCM 200 may contain one or more equations in the one or more memory components 218 defined in accordance with Curve C₄ in FIG. 7 or a similar curve to allow the VCM 200 to use an input such as an inching device input value to determine a braking rate while the inching pedal 250 is being depressed. Alternatively, the VCM 200 may include a lookup table stored in the one or more memory components 218 which stores points/data from a curve similar to or the same as curve C₄ from FIG. 7 such that an inching device input value may be used by the VCM 200 as an input into the lookup table and receive as an output from the lookup table a vehicle braking rate while the inching pedal 250 is being depressed.

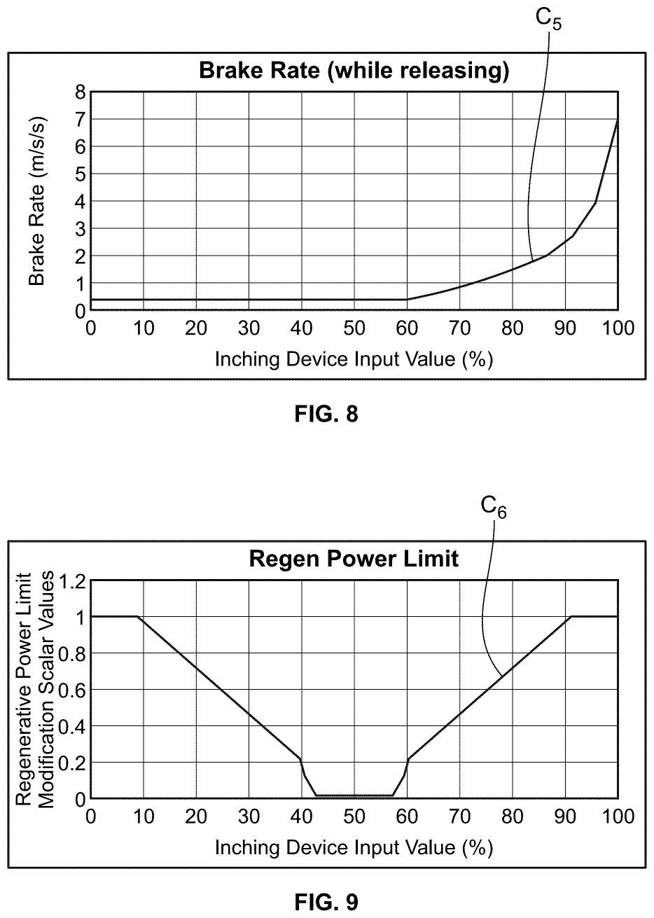

FIG. 8 provides an example curve C₅ illustrating how the VCM 200 may calculate a vehicle braking rate based on the inching device input signal when the inching control pedal 250 is being released such that the pedal 250 is moving outwardly toward a home position. Along the x-axis are inching device input values ranging from 0% or 0 units, which corresponds to 0 or a minimum inching pedal position to 100% or 100 units, which corresponds to maximum depressed inching pedal position. Along the y-axis are vehicle braking rates in units of m/s². To determine a vehicle braking rate when the inching pedal 250 is being released outwardly, the VCM 200 uses curve C₅ in FIG. 8 and a current inching device input value. For example, if the inching device input value is equal to 30% while the inching pedal 250 is being released, the vehicle braking rate is equal to about 0.39 m/s².

The VCM 200 may contain one or more equations in the one or more memory components 218 defined in accordance with Curve C₅ in FIG. 8 or a similar curve to allow the VCM 200 to use an input such as an inching device input value to determine a braking rate while the inching pedal 250 is being released. Alternatively, the VCM 200 may include a lookup table stored in the one or more memory components 218 which stores points/data from a curve similar to or the same as curve C₅ from FIG. 8 such that an inching device input value may be used by the VCM 200 as an input into the lookup table and receive as an output from the lookup table a vehicle braking rate while the inching pedal 250 is being released.

The VCM 200 may provide the TCM 220 with a target regenerative power limit when the vehicle is operating in a regenerative braking mode. A “regenerative braking mode” occurs when the vehicle target speed setpoint value is less than a current measured vehicle speed. The VCM 200 may determine the target regenerative power limit based on the inching device input signal. FIG. 9 illustrates an example curve C₆ providing values that the VCM 200 may use to calculate a target regenerative power limit based on the inching device input signal when the vehicle is operating in a regenerative braking mode. Along the x-axis are inching device input values ranging from 0% or 0 units, which corresponds to 0 or a minimum inching pedal position to 100% or 100 units, which corresponds to maximum depressed inching pedal position. Along the y-axis are regenerative power limit modification values. In the illustrated embodiment, the regenerative power limit modification values may comprise scalar or multiplication factors ranging from 0.0 to 1.2. To determine the target regenerative motor power limit when the vehicle is operating in the regenerative braking mode, a regenerative power limit modification value from FIG. 9 is multiplied by a default maximum regenerative traction motor power limit, which may comprise, for example, 60 kilowatts. The default maximum regenerative traction motor power limit may comprise any desired value. If, for example, the inching device input value is equal to 25%, the regenerative power limit modification value is equal to about 0.6, see FIG. 9. Hence, the regenerative power limit modification value, 0.6, is multiplied by the default value of 60 kilowatts, to calculate a target regenerative power limit of 36 kilowatts. The VCM 200 communicates the target regenerative power limit to the TCM 220 such that the TCM 220 will limit the power generated by each traction motor 222A and 222B to the target regenerative power limit as the TCM 220 attempts to slow the vehicle to the new vehicle target speed setpoint.

The TCM 220 will slow the vehicle at the braking rate determined from Curve C₄ or Curve C₅ of FIGS. 7 and 8 in an attempt to reach the vehicle target speed setpoint but only if the power generated by each traction motor 222A, 222B does not exceed the target regenerative power limit. If the total power generated by each traction motor 222A, 222B at the braking rate determined from Curve C₄ or Curve C₅ of FIGS. 7 and 8 would exceed the target regenerative power limit, the TCM 220 will modify the braking rate or velocity accordingly for each motor 222A, 222B so that the power generated by each motor 222A and 222B does not exceed the target regenerative power limit. Hence, the vehicle may slow at an actualized braking rate which differs from the braking rate determined from Curve C₄ or Curve C₅ of FIGS. 7 and 8. The mechanical brake(s) 224 may not be activated if the actualized braking rate for the vehicle does not equal the desired braking rate obtained from Curve C₄ or Curve C₅ of FIGS. 7 and 8 when the traction motors 222A, 222B are generating power at the target regenerative power limit.

The VCM 200 may contain one or more equations in the one or more memory components 218 defined in accordance with Curve C₆ in FIG. 9 or a similar curve to allow the VCM 200 to use an input such as an inching device input value to determine a regenerative power limit modification value. Alternatively, the VCM 200 may include a lookup table stored in the one or more memory components 218 which stores points/data from a curve similar to or the same as curve C₆ from FIG. 9 such that an inching device input value may be used by the VCM 200 as an input into the lookup table and receive as an output from the lookup table a regenerative power limit modification value for use when the vehicle is operating in the regenerative braking mode.

As noted above, the brake control device input sensor 230A is coupled to the VCM 200 such that the VCM 200 receives the brake control device input signal. The VCM 200 effects regenerative braking at a rate of deceleration corresponding to a brake control device input value. Braking occurs independent of the position of the inching device pedal 250, i.e., independent of any inching device input value. That is, the VCM 200 ignores inching device input values once it begins receiving the brake control device input signal. Regenerative braking may occur at the first and second traction drive motors 222A, 222B coupled respectively to the first and second driven wheels 212. If additional braking capacity is needed, the TCM 220 may instruct the VCM 200 to generate an actuation signal to a mechanical brake 224 coupled to each of the first and second traction drive motors 222A, 222B.

The “inching function,” provided by the technology set out herein, allows an operator to control the vehicle's speed with finesse so as to allow the operator to finely adjust the position of the vehicle 100 before committing to a full movement. Hence, an operator can very slowly move the vehicle 100 to engage the forks 156A, 156B with a pallet/load and/or very slowly move the vehicle 100 to position a load to be dropped by the vehicle. In an engine-based materials handling vehicle, an inching pedal may disconnect a transmission from a driven wheel and also function as a brake. The subject matter of this disclosure makes it seamless for an operator to move from an engine-based vehicle to an electric-based vehicle to operate the latter.

As noted above, the traction application 219 on the VCM 200 receives the traction control device input signals from the TCM 220. Based on the traction control device input signal, the VCM 200 determines a vehicle speed setpoint input value using, for example, the curve C₁ from FIG. 4. As also noted above, the traction application 219 on the VCM 200 monitors and samples the inching device input signals from the inching device input sensor 250A. Based on the inching device input signal, the VCM 200 determines a speed modification value, such as using the curve C₂ from FIG. 5, wherein the speed modification value may comprise a speed scalar value. The VCM 200 then multiplies the speed scalar value by the speed setpoint input value to determine a vehicle target speed setpoint. The VCM 200 then forwards the vehicle target speed setpoint to the TCM 220. The TCM 220 controls the operation of the traction motors 222A and 222B coupled to driven wheels 212 in an attempt to cause the vehicle to reach the vehicle target speed setpoint using defined limits of acceleration or braking rate and a maximum power limit.

When the vehicle is operating in a motoring mode, such that the target vehicle setpoint value is greater than the current measured vehicle speed, the predetermined vehicle acceleration value, discussed above, is used by the TCM 220, which value determines how quickly the TCM 220 increases the rotational speed of the traction motors 222A and 222B to cause the vehicle to reach the linear vehicle target speed setpoint. The TCM 220, when accelerating the motors 222A and 222B to cause the vehicle to reach the most recent vehicle target setpoint value, also takes into consideration a target motor power limit. The VCM 200 may determine the target motor power limit based on the inching device input signal. As discussed above, the VCM 200 may determine a motor power limit modification value using, for example, curve C₃ from FIG. 6, based on an inching device input value. The motor power limit modification value is then multiplied by a default maximum power limit, such as 60 kilowatts, to determine the target motor power limit. The VCM 200 provides the target motor power limit to the TCM 220. The TCM 220 will attempt to control the traction motors 222A and 222B to accelerate the vehicle at the predetermined acceleration value to reach the target setpoint speed. However, the TCM 220 cannot allow the power consumed by the traction motors 222A and 222B to exceed the target motor power limit when commanding the traction motors 222A and 222B to accelerate the vehicle to reach the target speed setpoint. This could result in an actualized acceleration rate of the vehicle which is less than the predetermined vehicle acceleration value as the TCM 220 attempts to increase the speed of the vehicle to the target speed setpoint.

When the vehicle target speed setpoint is less than a current measured vehicle speed, the VCM 200 will command the TCM 220 to control the traction motors 222A and 222B in an attempt to cause the vehicle to reach the vehicle target speed setpoint using a vehicle braking rate or deceleration value. Hence, the vehicle operates in the “regenerative braking mode” when slowing to reach a vehicle target speed setpoint, which vehicle speed setpoint is less than a current measured vehicle speed. As noted above, during an inching function, the braking rate value may vary based on whether the inching pedal is being depressed inwardly or released outwardly and also based the inching device input signal, i.e., the inching pedal position.

When the inching control pedal is being pressed inwardly, as noted above, the VCM 200 may calculate a vehicle braking rate using, for example, the curve C₄ in FIG. 7, based on an inching device input signal. When the inching control pedal is being released such that it moves towards it home position, the VCM 200 may calculate a vehicle braking rate using, for example, the curve C₅ in FIG. 8, based on an inching device input signal. The VCM 200 provides the braking rate to the TCM 220, which braking rate is used by the TCM 220 when controlling the speed and acceleration of the traction motors 222A and 222B to cause the vehicle to reach the most recent vehicle target speed setpoint, which setpoint is less than a current measured vehicle speed.

The TCM 220, when decelerating the vehicle to the new vehicle target setpoint value, also takes into consideration a target regenerative power limit. The VCM 200 may determine the target regenerative power limit based on the inching device input signal. As discussed above, the VCM 200 may determine a regenerative power limit modification value using, for example, curve C₆ from FIG. 9, based on an inching device input value. The regenerative power limit modification value is then multiplied by a default maximum power limit, such as 60 kilowatts, to determine the target regenerative power limit. The VCM 200 provides the target regenerative power limit to the TCM 220. The TCM 220 will attempt to control the traction motors 222A and 222B such that the vehicle achieves the desired braking rate without the power generated by each traction motor 222A and 222B exceeding the target regenerative power limit as the vehicle slows to reach the target setpoint speed. However, the TCM 220 will be limited to the target regenerative power limit when controlling the traction motors 222A and 222B to cause the vehicle to decelerate to reach the target speed setpoint. This could result in a change in the deceleration rate of the vehicle which differs from braking rate determined using the curve C₄ in FIG. 7 or the curve C₅ in FIG. 8 as the TCM 220 attempts to decrease the vehicle speed to the target speed setpoint.

Examples of calculating speed setpoint input values, speed modification values, vehicle target speed setpoint values, braking rates, target motor power limits and target regenerative power limits are set out below.

### EXAMPLE I

The traction control input value equals 70%. From curve C₁ in FIG. 4, the speed setpoint input value equals 3 m/s.

The inching device input value equals 50%. From curve C₂ in FIG. 5, the speed multiplication factor equals 0. The vehicle target speed setpoint equals 0×3 m/s=0 m/s.

Presuming the current speed is 1.0 m/s, the vehicle target speed setpoint equals 0 m/s, the inching pedal is being pressed inwardly and the inching device input value equals 50%, since the vehicle target speed setpoint is less than the current speed, the vehicle will operate in the regenerative braking mode. From curve C₄ in FIG. 7, the vehicle braking rate equals 0.39 m/s².

Presuming the inching device input value equals 50%, from curve C₆ in FIG. 9, the regenerative power limit modification value equals substantially 0. The target regenerative power limit equals 0×60 kilowatts=0 kilowatts. Since no power will be generated by the traction motors, the vehicle will coast.

### EXAMPLE II

The traction control input value equals 70%. From curve C₁ in FIG. 4, the speed setpoint input value equals 3 m/s.

The inching device input value changes from 90% to 70%; hence, the inching pedal is being released. From curve C₂ in FIG. 5, the speed multiplication factor equals 0. The target speed setpoint equals 0×3 m/s=0 m/s.

Presuming the current speed is 1.0 m/s, the target setpoint equals 0 m/s, the inching pedal is being released and the inching device input value equals 70%, since the target speed setpoint is less than the current speed, the vehicle will operate in the regenerative braking mode. From curve C₅ in FIG. 8, the braking rate equals 0.9 m/s².

Presuming the inching device input value equals 70%, from curve C₆ in FIG. 9, the regenerative power limit modification value equals substantially 0.41. The target regenerative power limit equals 0.41×60 kilowatts=24.6 kilowatts.

Vehicle braking occurs in this example at the rate of 0.9 m/s².

### EXAMPLE III

The traction control input value equals 70%. From curve C₁ in FIG. 4, the speed setpoint input value equals 3 m/s.

The inching device input value equals 10%. From curve C₂ in FIG. 5, the speed multiplication factor equals 0.9. The target speed setpoint equals 0.9×3 m/s=2.7 m/s.

Presuming the current speed is 1.0 m/s, the target setpoint equals 2.7 m/s, the inching pedal is being pressed and the inching device input value equals 10%, since the target speed setpoint is greater than the current speed, the vehicle will operate in the motoring mode. Hence, the TCM will control the traction motors such that the vehicle accelerates at the predefined acceleration value, e.g., 0.5 m/s².

Presuming the inching device input value equals 10%, from curve C₃ in FIG. 6, the motor power limit modification value equals 0.38. The target motor power limit equals 0.38×60 kilowatts=22.8 kilowatts.

In this example, the TCM will control the traction motors such that the vehicle accelerates at a rate of 0.5 m/s² so long as the power provided to the traction motors does not exceed 22.8 kilowatts.

If the inching device input value was 50%, it would be greater than the predefined inching device value of 41% from curve C₂ in FIG. 5. Further, from curve C₃ in FIG. 6, the motor power limit modification value would equal 0. Hence, the target motor power limit would equal 0×60 kilowatts=0 kilowatts. It is also noted that motor power limit modification values are equal to 0 between a first inching device input value of 43% and a second inching device input value of 57%, see curve C₃ in FIG. 6.

### EXAMPLE IV

The traction control input value equals 100%. From curve C₁ in FIG. 4, the speed setpoint input value equals 5.5 m/s.

The inching device input value equals 45%. From curve C₂ in FIG. 5, the speed multiplication factor equals 0. The target speed setpoint equals 0×5.5 m/s=0 m/s.

Presuming the current speed is 5.5 m/s, the target setpoint equals 0 m/s, the inching pedal is being pressed and the inching device input value equals 45%, since the target speed setpoint is less than the current speed, the vehicle will operate in the regenerative braking mode. From curve C₄ in FIG. 7, the braking rate equals 0.39 m/s².

Presuming the inching device input value equals 45%, from curve C₆ in FIG. 9, the regenerative power limit modification value equals 0. The target regenerative power limit equals 0×60 kilowatts=0 kilowatts.

On level ground, the vehicle will slowly coast to 0 m/s.

Traveling on a grade or slope, the vehicle will slow down at a rate determined by the slope of the grade unit it reaches 0 m/s, at which point the vehicle will begin to roll backwards down the grade. This simulates a full release of a clutch on an engine-based vehicle, where the clutch disconnects a transmission from a driven wheel.

### EXAMPLE V

The traction control input value equals 100%. From curve C₁ in FIG. 4, the speed setpoint input value equals 5.5 m/s and presume the actualized speed of the vehicle is 5.5 m/s.

The inching device input value is initially 0% but then changes to 45%. From curve C₂ in FIG. 5, the speed multiplication factor equals 0. The target speed setpoint equals 0×5.5 m/s=0 m/s.

Presuming the current speed is 5.5 m/s, the target speed setpoint equals 0 m/s, the inching pedal is being pressed and the inching device input value equals 45%, since the target speed setpoint is less than the current speed, the vehicle will operate in the regenerative braking mode. From curve C₄ in FIG. 7, the braking rate equals 0.39 m/s².

Presuming the inching device input value equals 45%, from curve C₆ in FIG. 9, the regenerative power limit modification value equals 0. The target regenerative power limit equals 0×60 kilowatts=0 kilowatts. Hence, the vehicle is coasting.

The operator then moves the inching pedal outward to the 20% position. From curve C₂ in FIG. 5, the speed multiplication factor equals 0.58. The target speed setpoint equals 0.58×5.5 m/s=3.19 m/s.

Since the operator is releasing the inching pedal, the braking rate will be taken from curve C₅ in FIG. 8. Hence, the braking rate equals 0.39 m/s².

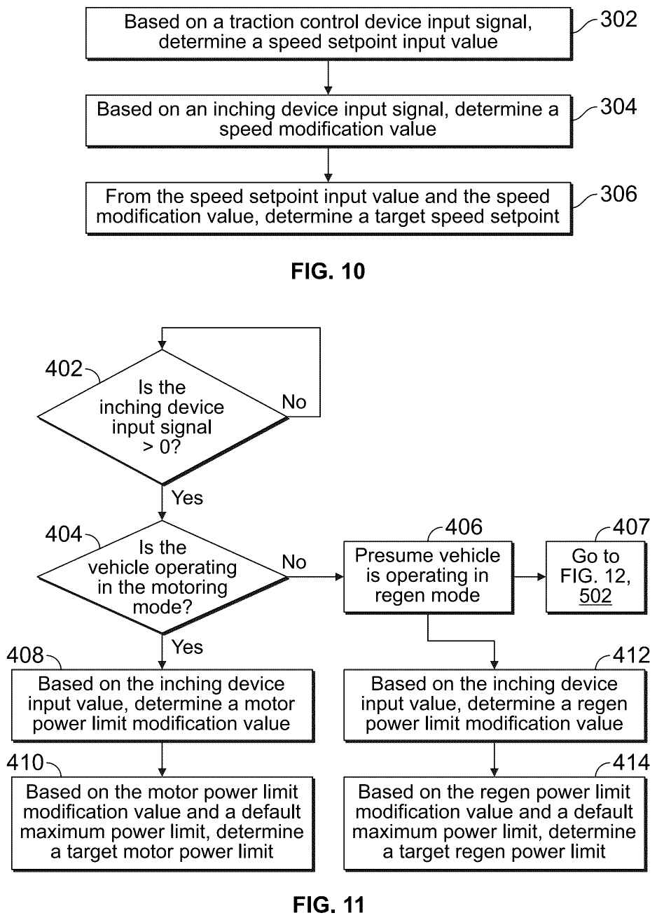

FIG. 10 is a flowchart of an example control algorithm or method for calculating a vehicle target speed setpoint. In step 302, the traction application 219 on the VCM 200 receives the traction control device input signal from the TCM 220. Based on the traction control device input signal, the VCM 200 determines a vehicle speed setpoint input value using, for example, the curve C₁ from FIG. 4.

In step 304, the traction application 219 on the VCM 200 monitors and samples the inching device input signals from the inching device input sensor 250A. Based on the inching device input signal, the VCM 200 determines a speed modification value, such as using the curve C₂ from FIG. 5, wherein the speed modification value may comprise a speed scalar value.

In step 306, the VCM 200 multiplies the speed scalar value by the speed setpoint input value to determine a vehicle target speed setpoint. The VCM 200 then forwards the vehicle target speed setpoint to the TCM 220. The TCM 220 controls the operation of the traction motors 222A and 222B coupled to driven wheels 212 in an attempt to cause the vehicle to reach the vehicle target speed setpoint.

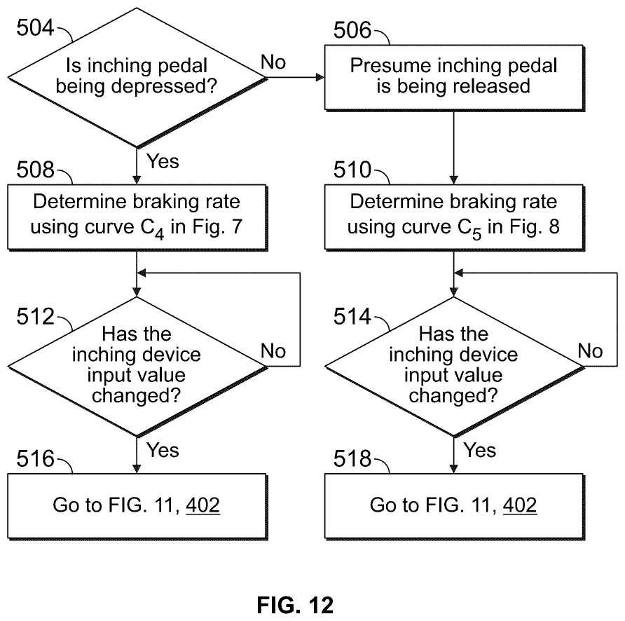

FIGS. 11 and 12 are flowcharts of example control algorithms or methods for calculating a power limit and a braking rate when the inching pedal is being activated.

In step 402, the VCM 200 determines if the inching device input signal is greater than zero, thereby indicating that the inching control pedal 250 has been activated. If not, the VCM 200 continues to sample and monitor the signal from the inching device input sensor 250A.

If the inching device input signal is greater than zero, in step 404, the VCM 200 determines if the vehicle is operating in the motoring mode. If the most recent vehicle target setpoint is greater than the current measured vehicle speed, the VCM 200 determines that the vehicle is operating in the motoring mode. If the most recent vehicle target setpoint is less than the current measured vehicle speed, the VCM determines that the vehicle is operating in the regenerative braking mode, see step 406.

If the vehicle is operating in the motoring mode, in step 408, the VCM 200 determines a motor power limit modification value using, for example, curve C₃ from FIG. 6, based on the inching device input value. In step 410, the VCM 200 multiples the motor power limit modification value by a default maximum power limit, such as 60 kilowatts, to determine a target motor power limit. The VCM 200 provides the target motor power limit to the TCM 220. The TCM 220 will attempt to control the traction motors 222A and 222B to accelerate the vehicle at the predetermined acceleration value to reach the most recent vehicle target setpoint speed. However, the TCM 220 cannot allow the traction motors 222A, 222B to consume power exceeding the target motor power limit when commanding the traction motors 222A and 222B to accelerate the vehicle to reach the target speed setpoint. This could result in an actualized acceleration rate of the vehicle which is less than the predetermined vehicle acceleration value as the TCM 220 attempts to increase the speed of the vehicle to the target speed setpoint.

If the VCM 200 determines that the vehicle is operating in the regenerative braking mode, see step 406, the VCM 200 will command the TCM 220 to control the traction motors 222A and 222B to cause the vehicle to reach the vehicle target speed setpoint at a vehicle braking rate or deceleration value. The TCM 220, when decelerating the vehicle to the new vehicle target setpoint value, also takes into consideration a target regenerative power limit. In step 412, the VCM 200 determines a regenerative power limit modification value using, for example, curve C₆ from FIG. 9, based on the inching device input value. In step 414, the VCM 200 multiplies the regenerative power limit modification value by a default maximum power limit, such as 60 kilowatts, to determine the target regenerative power limit. The VCM 200 provides the target regenerative power limit to the TCM 220. The TCM 220 will attempt to control the traction motors 222A and 222B such that the vehicle achieves the desired braking rate without the power generated by each traction motor 222A and 222B exceeding the target regenerative power limit as the vehicle slows to reach the target setpoint speed. It is noted that the regenerative power limit modification value is equal to 1 if the inching control pedal 250 is not being activated.

As noted above, if the VCM 200 determines that the vehicle is operating in the regenerative braking mode, see step 406, the VCM 200 will command the TCM 220 to control the traction motors 222A and 222B such that the vehicle reaches the vehicle target speed setpoint at a vehicle braking rate or deceleration value, see step 407 and FIG. 12. The VCM 200 determines in steps 504 and 506 if the inching pedal 250 is being depressed inwardly or released outwardly based on consideration of sequential inching device input values from the inching device input sensor 250A, which are sampled over time by the VCM 200. If the inching pedal is being depressed, the VCM 200, in step 508, uses curve C₄ in FIG. 7 to determine the braking rate, which the VCM 200 provides to the TCM 220. If the inching pedal is being released, the VCM 200, in step 510, uses curve C₅ in FIG. 8 to determine the braking rate, which the VCM provides to the TCM 220. The VCM 200 also determines if the inching device input value has changed, see steps 512, 514. If so, the VCM 200 returns to step 402, see steps 516 and 518.

The VCM 200 may determine the braking rate prior to determining the target regenerative power limit or vice versa.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A method comprising:
receiving, by one or more electronic processors on a materials handling vehicle:
an input from a traction control device;
an input from an inching device;
wherein the one or more electronic processors are collectively configured to:
determine a speed setpoint input value based on the traction control device input;
determine a speed modification value based on the inching device input;
determine a target speed setpoint based on the speed modification value and the speed setpoint input value; and
control a traction motor on the vehicle based on the target speed setpoint.

2. The method of claim 1, wherein when the inching device input is greater than a predefined inching device value, the speed modification value is equal to 0 such that the target speed setpoint is equal to zero units of speed.

3. The method of claim 2, wherein the inching device input has a range from 0% to 100%, the predefined inching device input value falls within a range from 1% to 70%.

4. The method of claim 1, wherein when the target speed setpoint is greater than a current vehicle speed, the one or more electronic processors determines an acceleration rate for the vehicle to reach the target speed setpoint independent of the inching device input.

5. The method of claim 1, wherein when the target speed setpoint is less than a current vehicle speed, the one or more electronic processors determines a braking rate for the vehicle to reach the target speed setpoint based on the inching device input.

6. The method of claim 5, wherein the inching device comprises an inching pedal, when the inching pedal is being depressed, a first lookup table is used by the one or more electronic processors to determine the braking rate and when the inching pedal is being released, a second lookup table different from the first lookup table is used by the one or more electronic processors to determine the braking rate.

7. The method of claim 1, wherein the traction motor is capable of operating in a motoring mode when the target speed setpoint is greater than a current vehicle speed or a regenerative braking mode when the target speed setpoint is less than the current vehicle speed, the one or more processors determines a power limit when the motor is operating in the motoring mode or the regenerative braking motor, wherein the power limit varies based on the inching device input.

8. The method of claim 7, wherein when the inching device input is greater than a predefined inching device value, the speed modification value is equal to 0 such that the target speed setpoint is equal to zero units of speed, when the traction motor is operating in the motoring mode, the one or more processors uses a motor power limit lookup table to determine a motor power limit modification value using the inching device input, the one or more processors determines a target motor power limit using the motor power limit modification value and a maximum motor power limit value.

9. The method of claim 8, wherein when the inching device input is greater than the predefined inching device value and between a first value and a second value, the power limit modification value is equal to zero resulting in the target power limit equal to 0 units of power, thereby causing the vehicle to coast.

10. The method of claim 7, wherein when the inching device input is greater than a predefined inching device value, the speed modification value is equal to 0 such that the speed target setpoint is equal to zero units of speed, when the traction motor is operating in the regenerative braking mode, the one or more processors use a regenerative power limit lookup table to determine a regenerative power limit modification value using the inching device input, the one or more processors determines a target regenerative power limit using the regenerative power limit modification value and a maximum regenerative power limit value.

11. A materials handling vehicle control system comprising:
one or more memory components storing executable instructions;
one or more electronic processors in communication with the one or more memory components;
a traction control device for generating a traction control device input;
an inching device for generating an inching device input;
execution of the executable instructions by the one or more electronic processors causes the one or more electronic processors to collectively:
determine: (i) a speed setpoint input value based on the traction control device input, (ii) a speed modification value based on the inching device input and (iii) a target speed setpoint based on the speed modification value and the speed setpoint input value; and
control a traction motor on the vehicle based on the target speed setpoint.

12. The materials handling vehicle control system of claim 11, wherein when the inching device input is greater than a predefined inching device value, the one or more processors determines that the speed modification value is equal to 0 and the speed target setpoint is equal to zero units of speed.

13. The materials handling vehicle control system of claim 12, wherein the inching device input has a range from 0% to 100%, the predefined inching device input value falls within a range from 1% to 70%.

14. The materials handling vehicle control system of claim 11, wherein when the target speed setpoint is greater than a current vehicle speed, the one or more electronic processors determines an acceleration rate for the vehicle to reach the target speed setpoint independent of the inching device input.

15. The materials handling vehicle control system of claim 11, wherein when the target speed setpoint is less than a current vehicle speed, the one or more electronic processors determines a braking rate for the vehicle to reach the target speed setpoint based on the inching device input.

16. The materials handling vehicle control system of claim 15, wherein the inching device comprises an inching pedal, when the inching pedal is being depressed, a first lookup table is used by the one more electronic processors to determine the braking rate and when the inching pedal is being released, a second lookup table different from the first lookup table is used by the one or more processors to determine the braking rate.

17. The materials handling vehicle control system of claim 11, wherein the one or more processors are capable of operating the traction motor in a motoring mode when the target speed setpoint is greater than a current vehicle speed or a regenerative braking mode when the target speed setpoint is less than the current vehicle speed, the one or more processors determines a power limit when the motor is operating in the motoring mode or the regenerative braking motor, wherein the power limit varies based on the inching device input.

18. The materials handling vehicle control system of claim 17, wherein when the inching device input is greater than a predefined inching device value, the speed modification value is equal to 0 such that the speed target setpoint is equal to zero units of speed, when the traction motor is operating in the motoring mode, the one or more processors uses a motor power limit lookup table to determine a motor power limit modification value using the inching device input, the one or more processors determines a target motor power limit using the motor power limit modification value and a maximum motor power limit value.

19. The materials handling vehicle control system of claim 18, wherein when the inching device input is greater than the predefined inching device value and between a first value and a second value, the power limit modification value is equal to zero resulting in the target power limit equal to 0 units of power, thereby causing the vehicle to coast.

20. The materials handling vehicle control system of claim 17, wherein when the inching device input is greater than a predefined inching device value, the speed modification value is equal to 0 such that the speed target setpoint is equal to zero units of speed, when the traction motor is operating in the regenerative braking mode, the one or more processors uses a regenerative power limit lookup table to determine a regenerative power limit modification value using the inching device input, the one or more processors determines a target regenerative power limit using the regenerative power limit modification value and a maximum regenerative power limit value.
